(19) United States
(12) Patent Application Publication
(10) Pub. No.: US 2007/0156850 A1
(43) Pub. Date: Jul. 5, 2007

(54) Secure remote access using portable storage device

(75) Inventor: Brad W. Corrion, Chandler, AZ (US)

Correspondence Address: INTEL CORPORATION;c/o INTELLEVATE, LLC, P.O. BOX 52050, MINNEAPOLIS, MN, 55402, US

(73) Assignee: Intel Corporation

(21) Appl. No.: 11/322,530

(22) Filed: Dec. 30, 2005

(51) Int. Cl. G06F 15/16

(52) U.S. Cl. 709/219

(57) ABSTRACT

In some embodiments a communication between a portable storage device and a local computer is detected and a secure connection is established between the local computer and a remote storage device in response to the detecting. Other embodiments are described and claimed.

### TECHNICAL FIELD

The inventions generally relate to secure remote access using a portable storage device.

### BACKGROUND

In order to use a public or shared computer (for example, a personal computer or PC) to access a private network share requires finding, installing, and configuring virtual private networking (VPN) software on the local host computer, logging in, and remembering to disconnect upon completion of use. This is always not a practical solution. For example, a user may have concerns about inadvertently providing access to strangers, having to install additional networking software, leaving residual software pollutions on public computers (for example, at public libraries, internet cafes, etc.), or having to memorize particular connection and/or configuration information. A major security issue for current software remote private network access using a public computer is a potential cloning of the identity of the connecting user. Therefore, a need has arisen for accessing a private network in order to access data remotely with increased security and less risk of providing access to strangers and/or cloning of the users identity, and without the requirements of installing additional networking software, leaving residual pollutions on public computers, and/or having to memorize connection and/or configuration information, etc.

### BRIEF DESCRIPTION OF THE DRAWINGS

The inventions will be understood more fully from the detailed description given below and from the accompanying drawings of some embodiments of the inventions which, however, should not be taken to limit the inventions to the specific embodiments described, but are for explanation and understanding only.

FIG. 1 illustrates an environment in which a user can map a shared drive to a remote computer and/or computer network according to some embodiments of the inventions.

FIG. 2 illustrates a USB key installed in a computer according to some embodiments of the inventions.

FIG. 3 illustrates an authentication according to some embodiments of the inventions.

FIG. 4 illustrates displayed storage device information according to some embodiments of the inventions.

FIG. 5 illustrates a flowchart according to some embodiments of the inventions.

### DETAILED DESCRIPTION

Some embodiments of the inventions relate to secure remote access using a portable storage device.

In some embodiments a communication between a portable storage device and a local computer is detected and a secure connection is established between the local computer and a remote storage device in response to the detecting.

In some embodiments an article includes a computer readable medium having instructions thereon which when executed cause a computer to detect a communication between a portable storage device and a local computer and to establish a secure connection between the local computer and a remote storage device in response to the detect.

According to some embodiments a network file share may be mapped as a local drive on a computer using a portable storage device (for example, a Universal Serial Bus key or USB key) as a physical metaphor and proxy. When coupled with a local computer (for example, when the USB key is inserted into a USB socket of the local computer) the storage device presents itself as a local file system (for example, in the same manner typically used by USB flash memory keys). When the user attempts to access contents of the drive (for example, by double-clicking on the drive) a virtual private network (VPN) is created using configuration information stored on the storage device (for example, a USB key). According to some embodiments a password or PIN (personal identification number) is requested of the user in order to complete the network connection. In order to complete the connection, the storage device (for example, USB key) utilizes network connections available to the host computer.

According to some embodiments a portable storage device (for example, a USB key) is used to access data from a remote computer and/or remote computer network. Many people are now familiar with using portable storage devices such as USB keys to mount file systems. This familiarity is expanded to allow a user to access a remote computer and/or network using such a portable storage device. The connection configuration for the network file share can be stored in the portable storage device to help any local host computer to access the remote computer or network.

According to some embodiments a USB key metaphor provides convenience and efficiency. In order to mount the share the portable storage device communicates with a local computer. The portable storage device may communicate with a local computer in a number of ways. For example, a USB key or other portable storage device can be plugged into a local computer or a portable storage device with wireless capabilities may be brought into a wireless range of a local computer. Once the portable storage device is communicating with a local computer a user may then type in a password and/or PIN, for example. A user can unmount the share by merely removing the communication between the portable storage device and the local computer (for example, by physically removing a USB key from a USB slot of the local computer). Such an arrangement reduces and/or removes any user concerns about providing access to the remote computer and/or network to strangers, having to install additional networking software, leaving residual software pollutions of public computers (for example, public library computers, internet cafes, etc.), or having to memorize connection and/or configuration information. A portable storage device (such as a USB key) also provides a degree of security to a user by preventing the identity of the connecting user from being cloned, for example (as is possible in previous software-only solutions).

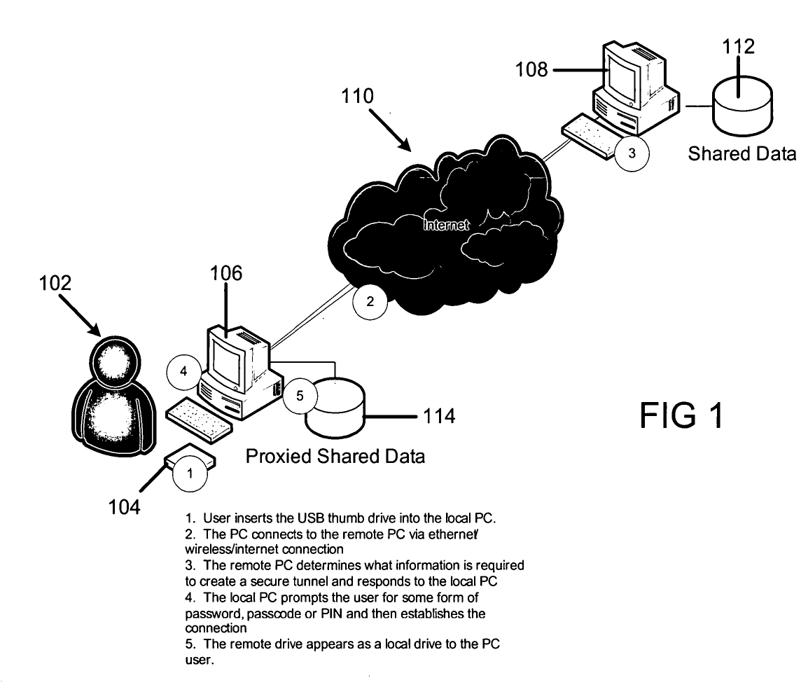

FIG. 1 illustrates an environment 100 in which a user can map a shared drive to a remote computer and/or computer network according to some embodiments. FIG. 1 illustrates how a portable storage device enables a user 102 to use a local computer 104 to map a shared drive of a remote computer and/or remote computer network.

According to some embodiments the user 102 inserts a portable storage device (for example, a USB key) into a portable storage device drive 104 (for example, a USB thumb drive) of a local computer 106 (for example, a personal computer) at “1” illustrated in FIG. 1. The local computer 106 then connects to a remote computer 108 (for example, a personal computer and/or a computer network) via one or more connections 110 (for example, via Ethernet, wireless, internet connections, etc.) as illustrated at “2” in FIG. 1. The remote computer 108 (and/or computer network) determines what information is needed to create a secure tunnel (as illustrated at “3” in FIG. 1) and responds to the local computer 106. The local computer 106 then prompts the user 102 for some form of password, pass code, PIN, etc. (as illustrated at “4” in FIG. 1) and then establishes the connection with the remote computer (and/or network) 108. A remote drive 112 of the remote computer 108 appears, for example, as a local drive to the user 102 of the local computer 106 (as illustrated at “5” in FIG. 1). It is noted that in some embodiments the remote drive 112 appears to the user 102 as a local drive on a graphical user interface (GUI) of the local computer 106, and that the data from the remote shared drive 112 is not actually moved from the remote shared drive 112 to a local drive 114.

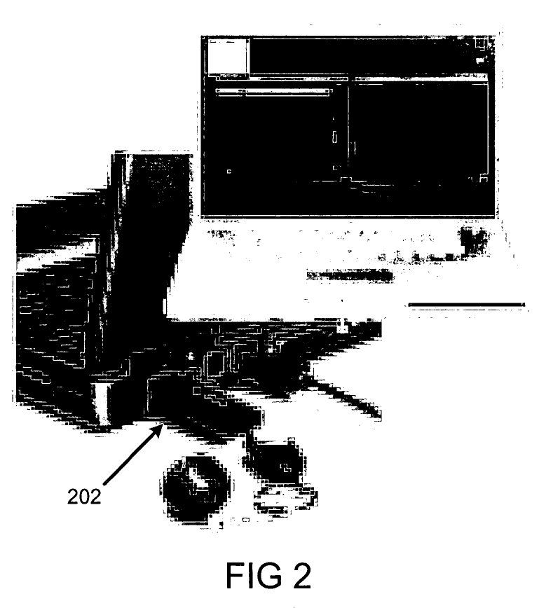

FIG. 2 illustrates a USB key 202 installed in a computer 200 according to some embodiments. According to some embodiments the USB key 202 is a portable storage device that is inserted into a USB slot on computer 200.

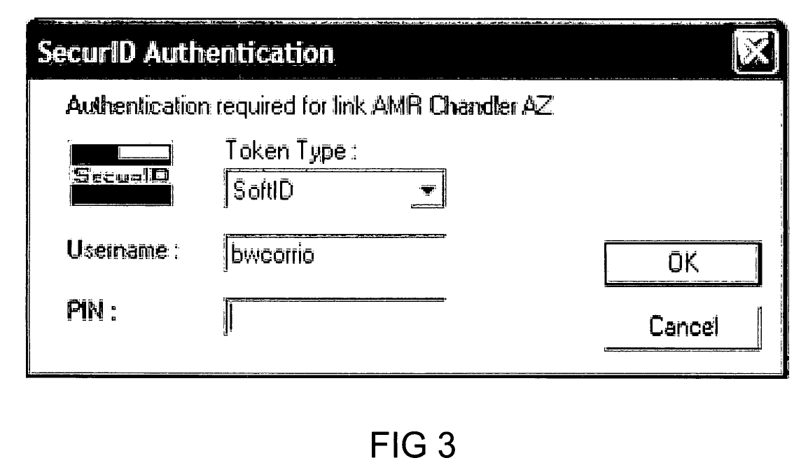

FIG. 3 illustrates an authentication 300 according to some embodiments. According to some embodiments a password, pass code, PIN, etc. must be entered by a user in order to enable a secure tunnel (for example, a virtual private network connection). Authentication 300 illustrates how a VPN may be set up, for example, by requiring a user to enter a PIN according to some embodiments. According to some embodiments authentication 300 is provided on a display of a local computer to request a password, pass code, PIN, etc. from a user.

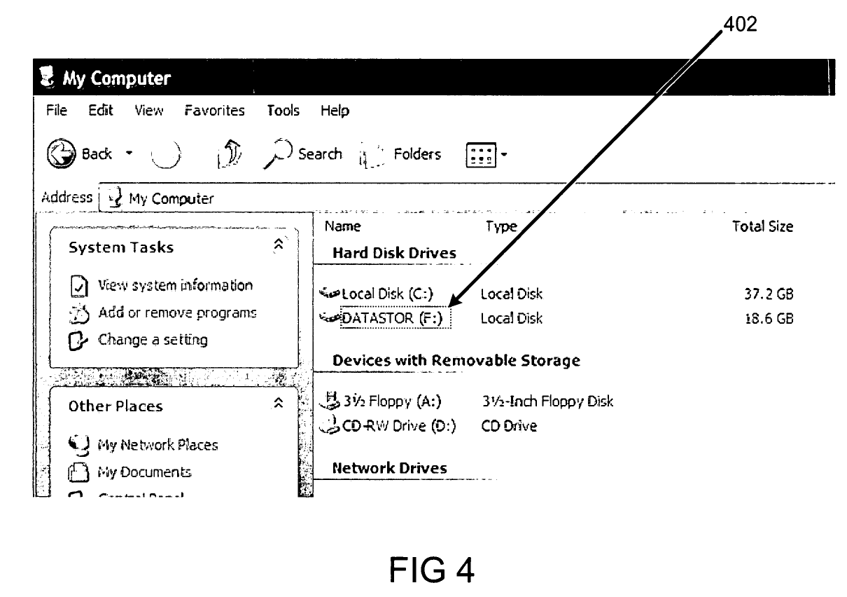

FIG. 4 illustrates displayed storage device information 400 according to some embodiments. According to some embodiments a remote drive appears as a local drive 402 (in FIG. 4 as “DATASTOR (F:)”). According to some embodiments the remote drive appears in a same manner that a USB media would typically appear on a computer display after the USB media is inserted into a computer, for example.

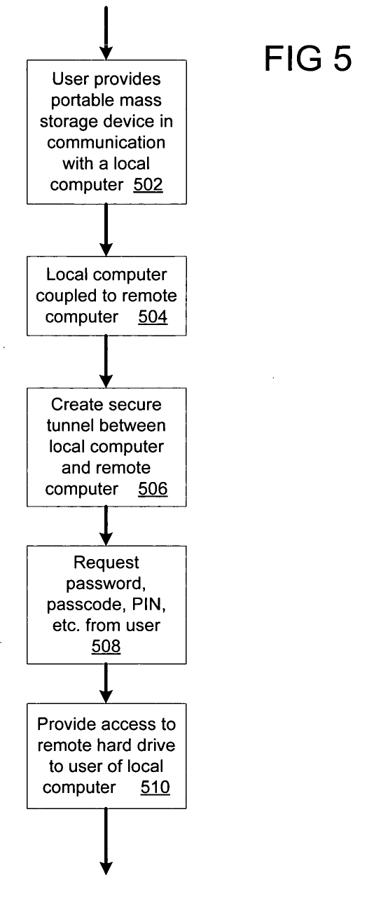

FIG. 5 illustrates a flowchart 500 according to some embodiments. At 502 a user provides a portable storage device in communication with a local computer (for example, by inserting a USB key into a USB drive of the local computer or putting a wireless portable storage device near the local computer in a wireless network that couples the portable storage device and the local computer). The local computer is then coupled to a remote computer at 504. A secure tunnel is created between the local computer and the remote computer at 506. A user is requested to enter password, pass code, PIN information, etc. at 508 (for example, input on the local computer). Access to a remote storage device is provided to the user at the local computer at 510 once the correct password, pass code, PIN, etc. information has been entered.

According to some embodiments mobile computing is promoted for personal and/or corporate use, and mobile computing is incorporated into the internet with a personal use model, for example. According to some embodiments, home computer users can access their home computers, hard drives, home networks, control devices in their home (for example, security cameras, nanny cams, still cameras, video cameras, home heating, home cooling, home lights, etc.) while they are away from home. Additionally, corporate users can access work accounts, data on hard drives, etc. without the requirement of having a work laptop with them (they may only be carrying a small USB key that provides VPN connection and/or configuration information, for example).

According to some embodiments a portable storage device such as a USB key may be used for typical USB key storage tasks (saving small files, pictures, important documents, etc.) while also being usable as a portable file system and/or remote access device. According to some embodiments a small portable storage device (for example, a USB key, flash memory device, memory card, memory stick, etc.) may be used for typical functions such as storing data, information, pictures, etc., while also being able to provide a remote file system along with having internal storage for connection and/or network configuration data. According to some embodiments a small portable storage device allows secure remote connections. Since a small physical device is used rather than merely software installed on a local computer “pollution” of the host computer and other potential problems associated with current remote access methods may be avoided.

Although some embodiments have been described in reference to particular implementations, other implementations are possible according to some embodiments. Additionally, the arrangement and/or order of circuit elements or other features illustrated in the drawings and/or described herein need not be arranged in the particular way illustrated and described. Many other arrangements are possible according to some embodiments.

In each system shown in a figure, the elements in some cases may each have a same reference number or a different reference number to suggest that the elements represented could be different and/or similar. However, an element may be flexible enough to have different implementations and work with some or all of the systems shown or described herein. The various elements shown in the figures may be the same or different. Which one is referred to as a first element and which is called a second element is arbitrary.

In the description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Some embodiments may be implemented in one or a combination of hardware, firmware, and software. Some embodiments may also be implemented as instructions stored on a machine-readable medium, which may be read and executed by a computing platform to perform the operations described herein. A machine-readable medium may include any mechanism for storing or transmitting information in a form readable by a machine (e.g., a computer). For example, a machine-readable medium may include read only memory (ROM); random access memory (RAM); magnetic disk storage media; optical storage media; flash memory devices; electrical, optical, acoustical or other form of propagated signals (e.g., carrier waves, infrared signals, digital signals, the interfaces that transmit and/or receive signals, etc.), and others.

An embodiment is an implementation or example of the inventions. Reference in the specification to “an embodiment,” “one embodiment,” “some embodiments,” or “other embodiments” means that a particular feature, structure, or characteristic described in connection with the embodiments is included in at least some embodiments, but not necessarily all embodiments, of the inventions. The various appearances “an embodiment,” “one embodiment,” or “some embodiments” are not necessarily all referring to the same embodiments.

Not all components, features, structures, characteristics, etc. described and illustrated herein need be included in a particular embodiment or embodiments. If the specification states a component, feature, structure, or characteristic “may”, “might”, “can” or “could” be included, for example, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

Although flow diagrams and/or state diagrams may have been used herein to describe embodiments, the inventions are not limited to those diagrams or to corresponding descriptions herein. For example, flow need not move through each illustrated box or state or in exactly the same order as illustrated and described herein.

The inventions are not restricted to the particular details listed herein. Indeed, those skilled in the art having the benefit of this disclosure will appreciate that many other variations from the foregoing description and drawings may be made within the scope of the present inventions. Accordingly, it is the following claims including any amendments thereto that define the scope of the inventions.

What is claimed is:

1. A method comprising:
detecting a communication between a portable storage device and a local computer; and
establishing a secure connection between the local computer and a remote storage device in response to the detecting.

2. The method of claim 1, wherein the communication between the portable storage device and the local computer includes a physical insertion of the portable storage device into a device associated with the local computer.

3. The method of claim 1, wherein the communication between the portable storage device and the local computer includes a wireless communication.

4. The method of claim 1, wherein the portable storage device is a flash memory device.

5. The method of claim 1, wherein the portable storage device is a Universal Serial Bus device.

6. The method of claim 1, wherein the secure connection includes a virtual private network.

7. The method of claim 1, further comprising ending the secure connection when the communication between the portable storage device and the local computer is no longer detected.

8. The method of claim 1, further comprising prompting a user, wherein the secure connection is established based on a user response to the prompting.

9. The method of claim 8, wherein the prompting includes at least one of prompting a user for a password, a pass code, and a PIN.

10. The method of claim 1, wherein the secure connection is established in response to configuration information stored on the portable storage device.

11. The method of claim 1, wherein the remote storage device is included in a remote computer.

12. The method of claim 1, wherein the remote storage device is included in a remote network.

13. The method of claim 1, further comprising displaying a representation of the remote storage device as an accessible storage device of the local computer.

14. An article comprising:
a computer readable medium having instructions thereon which when executed cause a computer to:
detect a communication between a portable storage device and a local computer; and
establish a secure connection between the local computer and a remote storage device in response to the detect.

15. The article of claim 14, wherein the communication between the portable storage device and the local computer includes a physical insertion of the portable storage device into a device associated with the local computer.

16. The article of claim 14, wherein the communication between the portable storage device and the local computer includes a wireless communication.

17. The article of claim 14, wherein the portable storage device is a flash memory device.

18. The article of claim 14, wherein the portable storage device is a Universal Serial Bus device.

19. The article of claim 14, wherein the secure connection includes a virtual private network.

20. The article of claim 14, the computer readable medium further having instructions thereon which when executed cause a computer to:
end the secure connection when the communication between the portable storage device and the local computer is no longer detected.

21. The article of claim 14, the computer readable medium further having instructions thereon which when executed cause a computer to:
prompt a user, wherein the secure connection is established based on a user response to the prompt.

22. The article of claim 21, wherein the prompting includes at least one of prompting a user for a password, a pass code, and a PIN.

23. The article of claim 14, wherein the secure connection is established in response to configuration information stored on the portable storage device.

24. The article of claim 14, wherein the remote storage device is included in a remote computer.

25. The article of claim 14, wherein the remote storage device is included in a remote network.

26. The article of claim 14, the computer readable medium further having instructions thereon which when executed cause a computer to:
display a representation of the remote storage device as an accessible storage device of the local computer.
